(19) United States
(12) Patent Application Publication
(10) Pub. No.: US 2016/0182435 A1
(43) Pub. Date: Jun. 23, 2016

(54) SOCIALLY ACCEPTABLE DISPLAY OF MESSAGING

(71) Applicant: Sony Corporation, Tokyo (JP)

(72) Inventors: Magnus Landqvist, Lund (SE); David de Léon, Lund (SE); Ola Thörn, Limhamn (SE); Günter Alce, Lund (SE)

(73) Assignee: SONY CORPORATION, Tokyo (JP)

(21) Appl. No.: 14/581,194

(22) Filed: Dec. 23, 2014

(51) Int. Cl. H04L 12/58

(52) U.S. Cl. CPC H04L 51/32; H04L 51/04

(57) ABSTRACT

A user device, such as a smart phone or an augmented reality glasses, receives data to be displayed to a first user, and the user device determines whether the first user is engaged in a social interaction with a second user. The user device presents the data for display to the first user when the first user and the second user are not engaged in the social interaction. For example, the user device may determine whether the second user is turned toward the first user for a threshold amount of time. When the first user is engaged in the social interaction with the second user, the user device withholds the data, determines a break in the social interaction, and presents the data to the first user during the break. The user device may modify the displayed data based on the duration of the break.

### TECHNICAL FIELD OF THE INVENTION

A disclosed implementation generally relates to a user device, such as smart telephone.

### DESCRIPTION OF RELATED ART

A user device, such as a smart telephone, portable computer, or camera, may include one or more sensors to collect data regarding a surrounding environment. The sensor may correspond to, for example, a camera to collect image data, a microphone to collect audio data, a gyroscope or accelerometer to collect information regarding a movement of the user device, or a location sensor (such a global positioning service, or GPS, unit) to collect information regarding a position of the user device. Furthermore, the user device may be programmed to automatically perform an action based on data collected by the sensor. For example, a camera may be programmed to automatically capture an image of a subject when the subject is looking in the direction of the camera.

### SUMMARY

According to one aspect, a method is provided. The method may include receiving, by a processor associated with a first user device and during a first time period, data to be displayed to a first user; determining, by the processor, whether the first user is engaged in a social interaction with a second user during the first time period; presenting, by the processor, the data for display to the first user during the first time period when the first user and the second user are not engaged in the social interaction during the first time period; when the first user is engaged in the social interaction with the second user during the first time period, determining, by the processor, a second time period associated with a break in the social interaction, wherein the second time period is subsequent to the first time period; and when the first user is engaged in the social interaction with the second user during the first time period, presenting, by the processor, the data for display to the first user during the second time period.

According to another aspect, a device is provided. The device may include a memory configured to store instructions; and a processor configured to execute one or more of the instructions to: receive, during a first time period, data to be displayed to a first user, determine whether the first user is engaged in the social interaction with a second user during the first time period, present the data for display to the first user during the first time period when the first user and the second user are not engaged in the social interaction during the first time period, determine, when the first user is engaged in the social interaction with the second user during the first time period, a second time period associated with a break in the social interaction, wherein the second time period is subsequent to the first time period, and present, when the first user is engaged in the social interaction with the second user during the first time period, the data for display to the first user during the second time period associated with the break.

According to another aspect, a non-transitory computer-readable medium is provided, The non-transitory computer-readable medium may store instructions, the instructions comprising one or more instructions that, when executed by a processor, cause the processor to: receive, during a first time period, data to be displayed to a first user, determine whether the first user is engaged in a social interaction with a second user during the first time period, present the data for display to the first user during the first time period when the first user and the second user are not engaged in the social interaction during the first time period, determine, when the first user is engaged in the social interaction with the second user during the first time period, a second time period associated with a break in the social interaction, wherein the second time period is subsequent to the first time period, and present, when the first user is engaged in the social interaction with the second user during the first time period, the data for display to the first user during the second time period associated with the break.

### BRIEF DESCRIPTION OF THE DRAWINGS

FIGS. 1A-1D show an environment in which concepts described herein may be implemented;

FIG. 2 shows exemplary components included in a communications device that may correspond to a user device included in the environment of FIGS. 1A-1D;

FIG. 3 shows exemplary components included in an augmented reality (AR) device that may correspond to a user device included in the environment of FIGS. 1A-1D;

FIG. 4 is a diagram illustrating exemplary components of a device included in the environment of FIGS. 1A-1D;

FIGS. 5 and 6 show flow diagrams of an exemplary processes for identifying and monitoring a social interaction between a first user and a second user and selectively providing display data to the first user based on a status of the social interaction; and

FIGS. 7A-7B show an example of using sensor data to identify a break in a social interaction within the environment of FIGS. 1A-1D.

### DETAILED DESCRIPTION OF PREFERRED EMBODIMENTS

The following detailed description refers to the accompanying drawings. The same reference numbers in different drawings may identify the same or similar elements.

The terms “user,” “consumer,” “subscriber,” and/or “customer” may be used interchangeably. Also, the terms “user,” “consumer,” “subscriber,” and/or “customer” are intended to be broadly interpreted to include a user device or a user of a user device. The term “document,” as referred to herein, includes one or more units of digital content that may be provided to a user. The document may include, for example, a segment of text, a defined set of graphics, a uniform resource locator (URL), a script, a program, an application or other unit of software, a media file (e.g., a movie, television content, music, etc.), or an interconnected sequence of files (e.g., hypertext transfer protocol (HTTP) live streaming (HLS) media files).

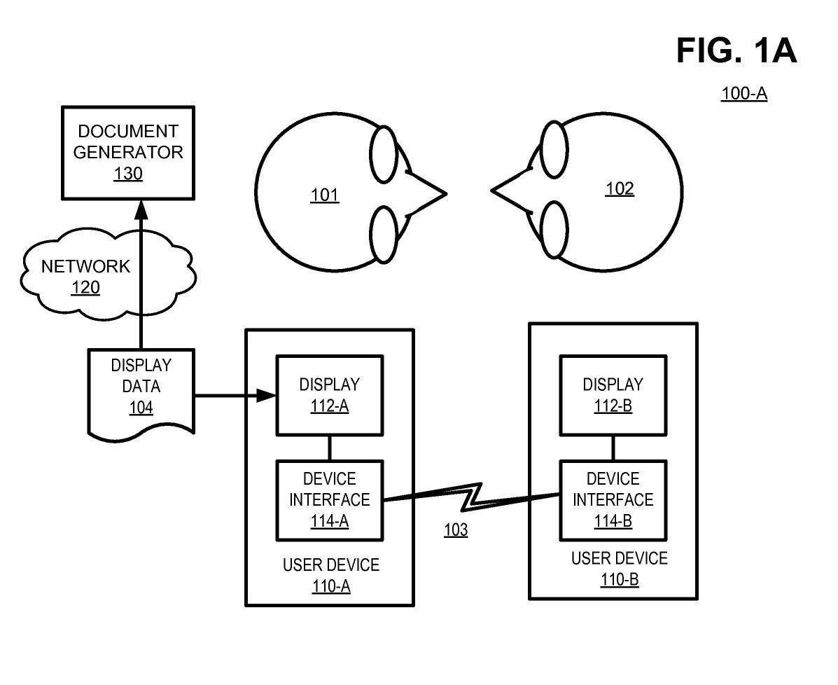

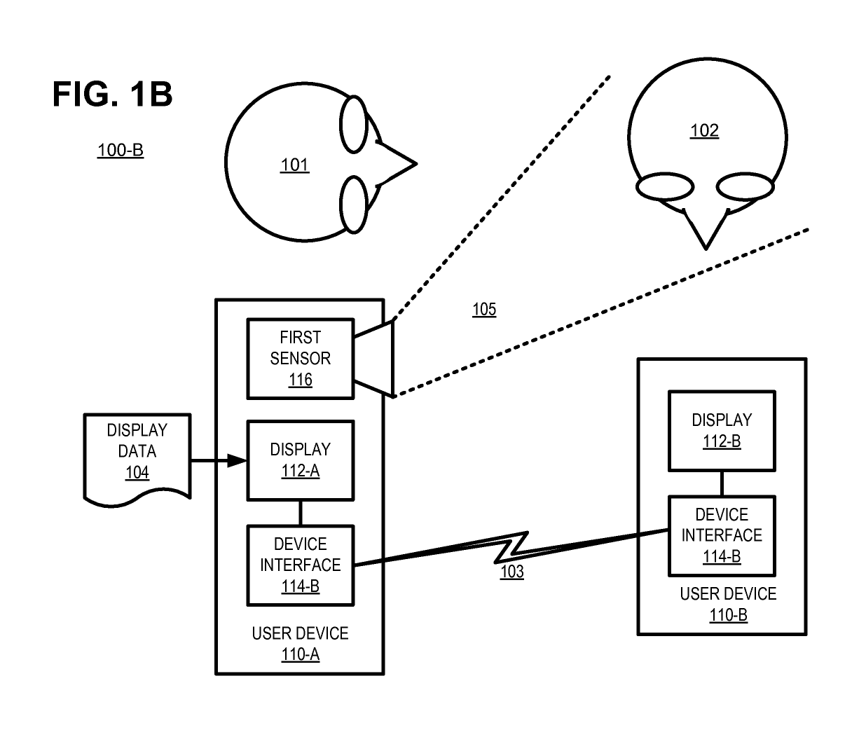

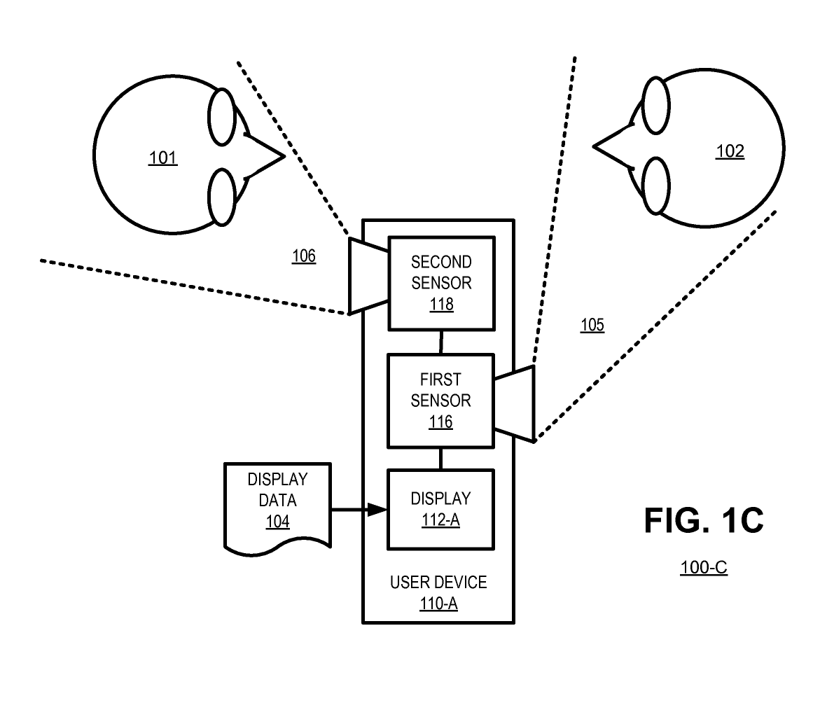

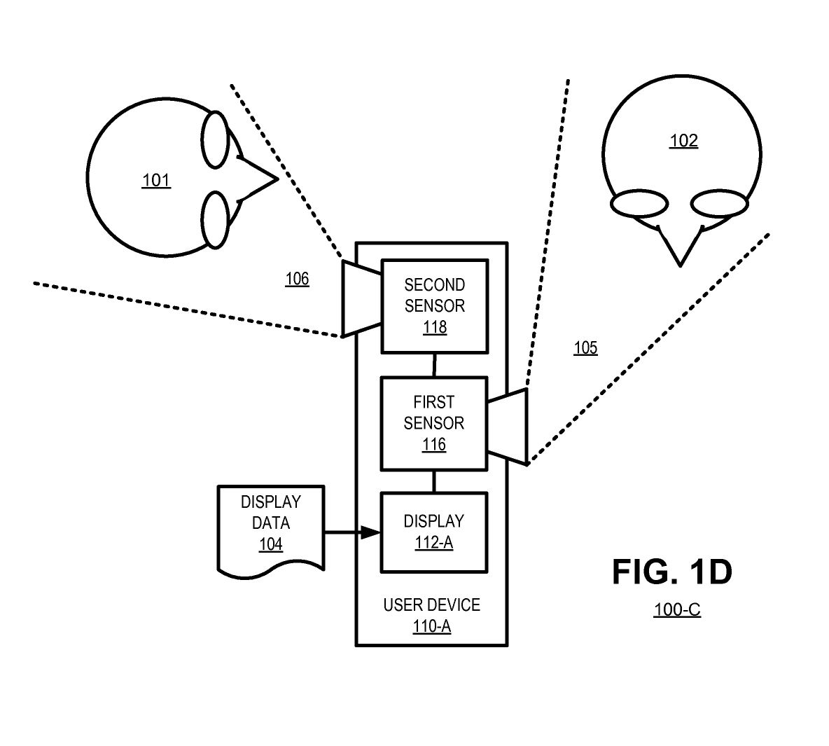

FIGS. 1A-1D show an environment 100 (labeled as environment 100-A in FIG. 1A, environment 100-B in FIG. 1B, and environment 100-C in FIGS. 1C and 1D) in which concepts described herein may be implemented. As shown in FIGS. 1A-1D, environment 100 may include a first user device 110-A that is associated with a first user 101, and first user device 110-A may collect data and may dynamically determine, based on the collected data, whether first user 101 is engaged in a social interaction (e.g., a conversation) with a second user 102. First user device 110-A may further generate or receive, via a network 120, display data 104, such as a notification or a message. First user device 110-A may determine whether to present display data 104 based on whether first user 101 and second user 102 are engaged in a social interaction. For example, user device 110-A may immediately present display data 104 if no social interaction is detected (e.g., no second user 102 is present and/or first user 101 and second user 102 are not socially engaged). Conversely, first user device 110-A may monitor a detected social interaction and may delay presentation of display data 104 until the social interaction ends and/or a break in the social interaction is detected. In one example, first user device 110-A may interface with a document generator 130 to dynamically modify display data 104 based on an expected duration of the break and may present the modified version of display data 104 during the break.

First user device 110-A and second user device 110-B may connect to network 120, for example, through a wireless radio link to exchange data. For example, first user device 110-A and/or second user device 110-B may include a portable computing and/or communications device, such as a personal digital assistant (PDA), a smart phone, a cellular phone, a laptop computer with connectivity to a cellular wireless network, a tablet computer, a wearable computer, etc. First user device 110-A and/or second user device 110-B may also include a portable user device such as a camera, watch, fitness tracker, etc. First user device 110-A and/or second user device 110-B may also include non-portable computing devices, such as a desktop computer, consumer or business appliance, set-top devices (STDs), or other devices that have the ability to connect to network 120.

In the example shown in FIG. 1A, first user device 110-A may include a display 112-A to selectively present display data 104 for display and a device interface 114-A to exchange status data 103 with a device interface 114-B associated with second user device 110-B. For example, device interfaces 114-A and 114-B may directly exchange status data 103 via a short-range data and communications protocol, such as a Bluetooth®, WiFi®, and/or Infrared Data Association (IrDA) based protocols. Additionally or alternatively, device interfaces 114-A and 114-B may exchange status data 103 via an intermediary node, such as a base station exchanging data via a wireless wide area network (WWAN) or a wireless router exchanging data via a wireless local area network (WLAN).

Status data 103 may include location and/or movement information associated with first user device 110-A and/or second user device 110-B, and first user device 110-A may use to the location information to determine whether first user 101 and second user 102 are engaged in a social interaction. For example, first user device 110-A may determine that first user 101 and second user 102 are engaged in a social interaction if first user device 110-A and second user device 110-B are located within a threshold distance (e.g. less than five meters) for more than a threshold duration of time (e.g., more than 10 seconds). In another example, first user device 110-A may determine that first user 101 and second user 102 are engaged in a social interaction if first user device 110-A and second user device 110-B are exchanging status data 103 via a short-range communications protocol (e.g. directly or via a same wireless router) for more than a threshold duration of time. In another example, status data 103 may include a connection request. First user device 110-A may identify a break in the social interaction if first user device 110-A and second user device 110-B move more that a threshold distance apart and/or cease to exchange status data 103 via the short-range communications protocol.

In another example, status data 103 may include information regarding the operation of first user device 110-A and/or second user device 110-B, and first user device 110-A may evaluate a social interaction between first user 101 and second user 102 based on the operation status. For example, first user device 110-A may determine that first user 101 and second user 102 are engaged in a social interaction first user 101 and second user 102 are in proximity of one another and first user device 110-A and/or second user device 110-B are inactive (e.g., displays 112-A and 112-B are not activated, a user input is not received, or another activity is not performed during a threshold duration of time). Similarly, first user device 110-A may infer a break in a previously detected social interaction when display 112-B is activated (e.g., second user 102 is reading a message) or an activity is performed on second user device 110-B (e.g., second user 102 places a call, activates an application, accessed data, etc.).

In yet another example, first user 101 and second user 102 may be located remotely and status data 103 may relate to interactions between first user 101 and second user 102. For example, status data 103 may include information regarding the status of a communication between first user 101 and second user 102 such as data regarding whether a telephone or video conference channel or session is active. Additionally or alternatively, status data 103 may include information regarding activity in the communications, such as an indication of whether first user 101 and second user 102 are conversing during a threshold time period.

After withholding display data 104 based on detecting a social interaction between first user 101 and second user 102, first user device 110-A may later present display data 104 via display 112-A when a break is detected in the social interaction.

In one implementation, first user device 110-A may selectively present display data 104 based on the expected duration of the break. For example, if display data 104 includes text data, first user device 110-A may determine an estimated amount of time for reading the text data and first user device 110-A may present display data 104 when the expected duration of the break exceeds the expected time for reading the text data.

First user device 110-A may estimate a duration of a break in a social interaction based on the status data 103. For example, first user device 110-A may determine an activity being performed by second user 102, and first user device 110-A may estimate a duration of a break in a social interaction based on the activity. For example, if second user 102 is reading a message, first user device 110-A may estimate the duration of the social break based on an expected time for second user 102 to read the message.

In other implementations described below with respect to FIGS. 1B-1D, first user device 110-A may estimate a duration of a break in a social interaction based on information collected from second user 102. For example, first user device 110-A may collect measurements indicating the extent that second user 102 moves and/or turns away from first user 101, and first user device 110-A may estimate the duration of the break based on the measurements.

Referring back to FIG. 1A, network 120 may include any network or combination of networks. In one implementation, network 120 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Alternatively or in addition, network 120 may include a content delivery network having multiple nodes that exchange data with user device 110. Although shown as a single element in FIG. 1A, network 120 may include a number of separate networks that function to provide communications and/or services to first user device 110-A.

In one implementation, network 120 may include a closed distribution network. The closed distribution network may include, for example, cable, optical fiber, satellite, or virtual private networks that restrict unauthorized alteration of contents delivered by a service provider. For example, network 120 may also include a network that distributes or makes available services, such as, for example, television services, mobile telephone services, and/or Internet services. Network 120 may be a satellite-based network and/or a terrestrial network.

Document generator 130 may include a component that generates a document presenting display data 104 based on, for example, the expected duration of a social break. Document generator 130 may further generate/modify a document for presenting display data 104 based on a reading speed for first user 101 and/or information specifying data to include/exclude from display data 104.

To generate a document for presenting display data 104, document generator 130 may store an original document and may modify the original document based on the data received from first user device 110-A regarding the interaction. For example, the original document may be designed to be read in a certain length of time. If first user device 110-A determines that the expected break is less than the expected time needed to read the original document, document generator 130 may modify the original document to form a modified document that can be read by first user 101 in less time. For example, document generator 130 may remove one or more sections of the original document, simplify the language, grammar, and/or presentation of the original document, etc., to allow first user 101 to read the resulting display data 104 in less time.

Conversely, if first user device 110-A determines that the expected break is greater than the expected time to read the original document, document generator 130 may modify the original document to generate display data 104 that is longer, more complex, etc. For example, document generator 130 may modify the language, grammar, and/or presentation of the original document to cause first user 101 to take more time to read the resulting display data 104. Additionally or alternatively, document generator 130 may add one or more sections to the original document. For example, document generator 130 may identify one or more key terms (e.g., terms that frequently appear in prominent locations) in the original document and add additional content (e.g., text, images, multimedia content) related to the key terms when generating display data 104. To identify possible content to add to the original document, document generator may generate a search query and use the query to perform a search to identify relevant content on the Internet or in a data repository (e.g., using a search engine).

In another example, pre-prepared documents may be divided into paragraphs, and the paragraphs may be ranked by importance. When generating display data 104, document generator 130 may first include one or more paragraphs ranked as more important and/or exclude one or more paragraphs ranked as less important in display data 104.

In one implementation, document generator 130 may determine the expected time to read the original document and/or generated display data 104 based on statistics (e.g., the average number of words per minute) associated with an ordinary reader. Alternatively, document generator 130 may determine the expected time required to read the original document and/or generated display data 104 based on data received from first user device 110-A. For example, first user device 110-A may determine an amount of time that first user 101 takes to read other documents, and document generator 130 may use this information to determine an individualized reading speed for first user 101 based on the length, complexity, etc. of the other documents.

In one implementation, document generator 130 may dynamically create display data 104 based on the data received from first user device 110-A (e.g., document generator 130 does not create display data 104 from a template). For example, document generator 130 may use document generation software such as Yseop® or Narrative Solutions®. For example, document generator 130 may identify a target group (e.g., an educational level, age, etc.) associated with first user 101 (e.g., based on the available break time) and may generate display data 104 based on attributes of the target group.

It should be further appreciated that although display data 104 is described as being read by first user 101 (e.g., that first user 101 is reviewing text within display data 104), display data 104 may include multimedia content, such as audio and/or video content. Document generator 130 may modify multimedia content based on a length of the break in the social interaction. For example, document generator 130 may remove certain portions (e.g., remove the credits) or may otherwise modify the playtime of the multimedia content (e.g., by modifying an associated playback speed).

Additionally or alternatively to modifying the content included in display data 104, document generator 130 may further modify a writing style for display data 104 to modify the amount of time that it would take for first user 101 to read display data 104. For example, document generator 130 may change the complexity of text within display data 104 (e.g., average number of letters per word, average number of words per sentence, etc.) to change an associated reading time. Document generator 130 may also change the grammar associated with display data 104, such as to vary the sentence structure and placement of terms, modify descriptive clauses, etc. to achieve a desired reading time.

First user device 110-A may dynamically detect and monitor a social interaction between first user 101 and second user 102 based on different or additional factors. For example, in environment 100-B shown in FIG. 1B, first user device 110-A may include a first sensor 116 to collect first sensor data 105 regarding first user 101 and/or second user 102, and first user device 110-A may evaluate a social interaction between first user 101 and second user 102 based on status data 103 and first sensor data 105.

First sensor 116 may include one or more components to detect data regarding first user 101, second user 102, and/or surrounding environment 100-B. For example, First sensor 116 may include a location detector, such as a sensor to receive a global positioning system (GPS) or other location data, or a component to dynamically determine a location of first user device 110-A (e.g., by processing and triangulating data/communication signals received from base stations). Additionally or alternatively, first sensor 116 may include a motion sensor, such as a gyroscope or accelerometer, to determine movement of user device 110.

Additionally or alternatively, first sensor 116 may include a sensor to collect information regarding first user 101, second user 102, and/or environment 100-B. In one example, first sensor 116 may include an audio sensor (e.g., a microphone) to collect audio data associated with first user 101 and/or second user 102, and first user device 110-A may process the audio data to evaluate a social interaction between first user 101 and second user 102. For example, when status data 103 indicates that first user device 110-A and second user device 110-B are within a threshold distance of each other, first user device 110-A may evaluate audio data collected by first sensor 116 to determine whether first user 101 and second user 102 are conversing (e.g., whether speech is detected). First user device 110-A may infer a break in the social interaction if, for example, audio data (e.g., a conversation) from first user 101 and/or second user 102 is not detected by first sensor 116 during a threshold time period. For example, the audio data may be processed to determine if second user 102 is not responding during a threshold time period, and therefore, not paying attention to first user 101/

In another example, first sensor 116 may include an image sensor (e.g., a camera) to collect image data associated with first user 101 and/or second user 102. In the example shown in FIG. 1B, when status data 103 indicates that first user device 110-A and second user device 110-B are within a threshold distance of each other, first user device 110-A may evaluate the image data to determine whether second user 102 is looking in the direction of first user 101. First user device 110-A may determine whether that first user 101 and second user 102 are engaged in a social interaction if second user 102 is looking in the direction of first user 101 for at least a threshold amount of time.

First user device 110-A may evaluate facial features included in an image of second user's 102 face. For example, first user device 110-A may determine that second user 102 is looking in the direction of first user 101 if the image includes both of second user's 102 eyes, the eyes are not blocked by another facial element (e.g., second user's 102 nose), the eyes are of substantially equal size (e.g., less than 10% different in width), the eyes are at least a threshold distance apart, etc. First user device 110-A may detect a break in the social interaction based on detected changes in the images. For example, first user device 110-A may infer a break in the social interaction if, for example, the image data indicates that second user 102 has turned away from first user 101 (e.g., first sensor data 105 includes image data that does not show both of second user's 102 eyes).

In another example, first user device 110-A may determine that first user 101 and second user 102 are travelling together (e.g., in single automobile or a public transportation vehicle such as a bus or train) if first sensor data 105 indicates that the both first user device 110-A and second user device 110-B are moving at a common speed and a common direction. First user device 110-A may determine that first user 101 and second user 102 and engaged in a social interaction while riding on the public transportation, and first user device 110-A may delay presentation of display data 104 until the end of the ride. The estimated time associated with the public transportation vehicle may be set by first user 101 and/or or may be determined based on various factors and/or data collected from other sources, such as the distance of the route traversed by the public transportation vehicle, the velocity of the public transportation vehicle, traffic conditions, etc. In one implementation, the estimated time for travelling in the public transportation vehicle may be modified based on a time spent by first user 101 and/or or second user 102 on a prior ride on the public transportation vehicle.

In another example, first sensor 116 may include or interface with a sensor device, such as a fitness monitor, that identifies attributes of first user 101, such as the user's heart rate, body temperature, respiration rate, etc. First user device 110-A may use the information regarding first user 101 to further identify associated activities, and first user device 110-A may identify a time (e.g., a break in the activity) to present display data 104 based on the determined activities. For example, if first user 101 has an elevated heart rate and is moving at a particular velocity range, first user device 110-A may determine that first user 101 and second user 102 are walking together, and first user device 110-A may estimate an time when the activities ends based on identifying an expected destination (that is, in turn, identified based on prior movements by first user 101, addresses associated with contacts, etc.) and identify an amount of time it would take first user 101 to walk to the destination at a current velocity.

In another implementation, first user device 110-A may detect and monitor a social interaction between first user 101 and second user 102 without interfacing with second user device 110-B. For example, in environment 100-C shown in FIGS. 1C and 1D, first user device 110-A may include first (e.g., outgoing) sensor 116 to collect first sensor data 105 regarding second user 102, and a second sensor 118 to collect second sensor data 106 regarding first user 101. First user device 110-A may then evaluate first sensor data 105 and second sensor data 106 to identify and monitor a social interaction between first user 101 and second user 102.

For example, in environment 100-C in FIG. 1C, first user device 110-A may detect a social interaction between first user 101 and second user 102 when first user 101 and second user 102 are located within a threshold distance of first user device 110-A, and first user 101 and second user 102 are facing one another. For example, first user device 110-A may determine that first user 101 and second user 102 are located within a threshold distance of each other if faces of first user 101 and second user 102 are at least a threshold size in images captured by first sensor 116 and second sensor 118. First user device 110-A may determine that first user 101 and second user 102 are looking at each other when a face of first user 101 is detected by first sensor 116 and a face of second user 102 is detected by second sensor 118. Additionally or alternatively, first user device 110-A may determine that first user 101 and second user 102 are engaged in a conversation if voice data for first user 101 and second user 102 is detected by first sensor 116 and/or second sensor 118.

In another example, first user device 110-A may perform facial analysis of image data included in first sensor data 105 and/or second sensor data 106. For example, first user device 110-A may determine whether first user 101 and second user 102 are smiling or displaying other facial indications associated with a social interaction. First user device 110-A may also perform speech-to-text analysis of audio data included in first sensor data 105 and/or second sensor data 106. For example, first user device 110-A may determine whether first user 101 and second user 102 are uttering greetings or other phrases associated with a social interaction.

As shown in environment 100-C in FIG. 1D, first user device 110-A may detect a break in a social interact between first user 101 and second user 102 based on first sensor data 105 and/or second sensor data 106. For example, first user device 110-A may detect a break in the social interaction when image data collected by first sensor 116 indicates that second user 102 is looking away from first user 101. For example, first user device 110-A may determine whether an image of second user 102 includes a front view (e.g., the image includes both of second user's 102 eyes) or a side view (e.g., the image includes one of second user's 102 eyes). Additionally or alternatively, first user device 110-A may identify a break in a social interaction when first sensor data 105 (e.g., image data) indicates that second user 102 is looking toward second user device 110-B (e.g., second user 102 is reading a message) and/or toward another user (not shown). First user device 110-A may then present display data 104 via display 112-A while second user 102 is looking away from first user 101. In this way, first user device 110-A may present display data 104 without interfering in a social interaction between first user 101 and second user 102.

Although FIGS. 1A-1D depict exemplary components of environment 100-A through 100-C, in other implementations, environment 100-A through 100-C may include fewer components, additional components, different components, or differently arranged components than those illustrated in FIGS. 1A-1D. For example, FIGS. 1A-1D show display 112-A as a component in first user device 110-A, but in other implementations, display 112-A may be a different device, such as a monitor, an e-reader, or another user device, and first user device 110-A may forward (e.g., via network 120) instructions to cause display 112-A to present display data 104 during a detected break in a social interaction between first user 101 and second user 102.

Furthermore, one or more components of environment 100 may perform one or more tasks described as being performed by one or more other components of environment 100. For example, document generator 130 may be coupled to or be included as a component of first user device 110-A such that first user device 110-A obtains display data 104 locally (e.g., without exchanging data via network 120). For example, document generator 130 may be an application or component residing on first user device 110-A.

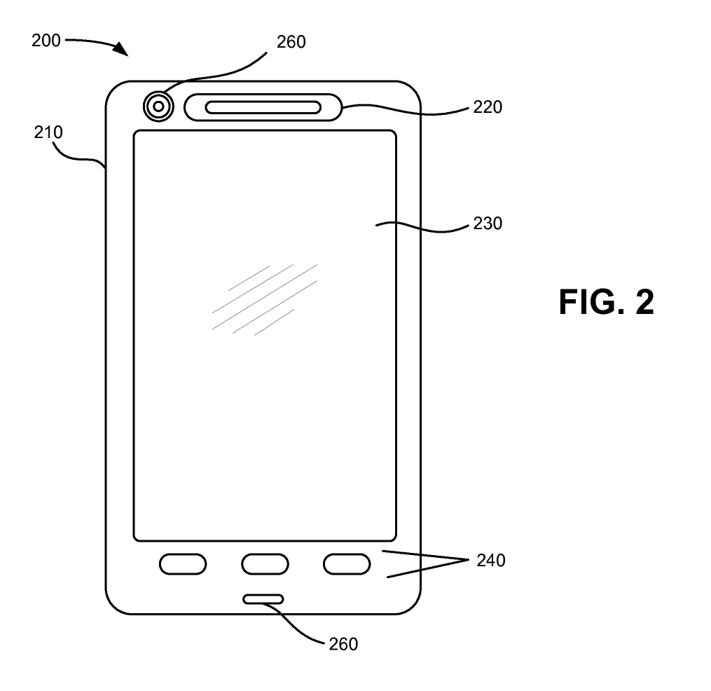

FIG. 2 shows an exemplary communications device 200 that may correspond to first user device 110-A and/or second user device 110-B. As shown in FIG. 2, communications device 200 may include a housing 210, a speaker 220, a touch screen 230, control buttons 240, a microphone 250, and/or a camera element 260. Housing 210 may include a chassis via which some or all of the components of communications device 200 are mechanically secured and/or covered. Speaker 220 may include a component to receive input electrical signals from communications device 200 and transmit audio output signals, which communicate audible information to a user of communications device 200. In one example, first user device 110-A may selectively output display data 104 audibly via speaker 220.

Touch screen 230 may include a component to receive input electrical signals and present a visual output in the form of text, images, videos and/or combinations of text, images, and/or videos which communicate visual information to the user of communications device 200. In one implementation, touch screen 230 may selectively present display data 104. In one implementation, touch screen 230 may display text input into communications device 200, text, images, and/or video received from another device, and/or information regarding incoming or outgoing calls or text messages, emails, media, games, phone books, address books, the current time, etc. Touch screen 230 may also include a component to permit data and control commands to be inputted into communications device 200 via touch screen 230. For example, touch screen 230 may include a pressure sensor to detect touch for inputting content to touch screen 230. Alternatively or in addition, a capacitive or field sensor to detect touch.

Control buttons 240 may include one or more buttons that accept, as input, mechanical pressure from the user (e.g., the user presses a control button or combinations of control buttons) and send electrical signals to a processor (not shown) that may cause communications device 200 to perform one or more operations. For example, control buttons 240 may be used to cause communications device 200 to transmit information.

Microphone 250 may include a component to receive audible information from a user and send, as output, an electrical signal that may be stored by communications device 200, transmitted to another user device, or cause the device to perform one or more operations. In one implementation, microphone 250 may capture audio data related to first user 101 and/or second user 102, and communication device 200 may identify a social interaction and a break in the social interaction based on the audio data.

Camera element 260 may be provided on a front or back side of communications device 200, and may include a component to receive, as input, analog optical signals and send, as output, a digital image or video that can be, for example, viewed on touch screen 230, stored in the memory of communications device 200, discarded and/or transmitted to another communications device 200. In one implementation, camera element 260 may capture image data related to first user 101 and/or second user 102, and communication device 200 may identify a social interaction and a break in the social interaction based on the image data.

Although FIG. 2 depicts exemplary components of communications device 200, in other implementations, communications device 200 may include fewer components, additional components, different components, or differently arranged components than illustrated in FIG. 2. Furthermore, one or more components of communications device 200 may perform one or more tasks described as being performed by one or more other components of communications device 200. For example, communications device 200 may include an interface to couple to additional sensors (e.g., a fitness tracker, an external camera, etc.).

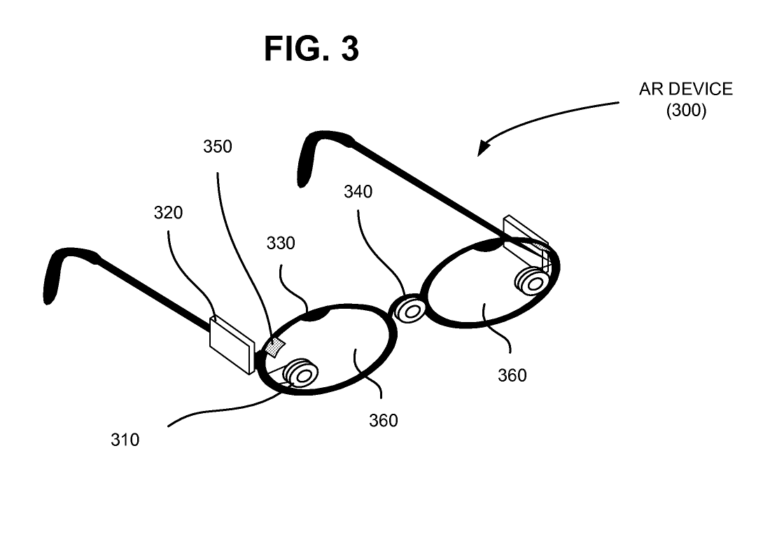

FIG. 3 shows exemplary components that may be included in an augmented reality (AR) device 300 that may correspond to first user device 110-A and/or second user device 110-B. AR device 300 may correspond, for example, to a head-mounted display (HMD) that includes a display device paired to a headset, such as a harness or helmet. HMDs place images of both the physical world and virtual objects over the user's field of view. AR device 300 may also correspond to AR eyeglasses. For example, AR device 300 may include eye wear that employ cameras to intercept the real world view and re-display an augmented view through the eye pieces and devices in which the AR imagery is projected through or reflected off the surfaces of the eye wear lens pieces.

As shown in FIG. 3, AR device 300 may include, for example, a depth sensing camera 310, sensors 320, eye camera(s) 330, front camera 340, projector(s) 350, and lenses 360. Depth sensing camera 310 and sensors 320 may collect depth, position, and orientation information of objects viewed by a user in the physical world. For example, depth sensing camera 310 (also referred to as a “depth camera”) may detect distances of objects relative to AR device 300. Sensors 320 may include any types of sensors used to provide information to AR device 300. Sensors 320 may include, for example, motion sensors (e.g., an accelerometer), rotation sensors (e.g., a gyroscope), a microphone, sand/or magnetic field sensors (e.g., a magnetometer).

Continuing with FIG. 3, eye cameras 330 may track eye movement to determine the direction in which the user is looking in the physical world. Front camera 340 may capture images (e.g., color/texture images) from surroundings, and projectors 350 may provide images and/or data to be viewed by the user in addition to the physical world viewed through lenses 360. For example, AR device 300, when worn by first user 101, may use data collected from front camera 340 to identify whether first user 101 is looking toward or away from second user 102 and may use this information to determine that status of a social interaction between first user 101 and second user 102.

In operation, AR device 300 may determine actions of first user 101 via sensors 320 (e.g., determining whether first user 101 is moving or staying in one position) and/or capture images (e.g., activate eye cameras 330 to determine when first user 101 is viewing display data 104 and/or activate front camera 340 to collect information regarding second user 102 and or a surrounding environment). For example, AR device 300 (or another device) may use data collected from eye cameras 330 to identify a time period when first user 101 is looking at second user 102 and may use this information to determine the status of a social interaction between first user 101 and second user 102. In another example, AR device 300 (or another device) may use data collected from eye cameras 330 to identify amounts of time that first user 101 views different portions of a document. Document generator 130 may use this information when generating/modifying display data 104 to achieve a desired reading time. AR device 300 may then selectively present display data 104 (e.g., via projector 350) when a break in a social interaction is detected based on data collected from eye cameras 330 and/or camera 340. For example, projector 350 may provide display data 104 to first user 101 when camera 340 records image data indicating that second user 102 is looking away from first user 101 (e.g., looking toward second user device 110-B or another user). In this way, AR device 300 may selectively present or cause another device (not shown) to selectively present display data 104 in a socially appropriate manner and without disrupting a social interaction between first user 101 and second user 102.

Although FIG. 3 depicts exemplary components of AR device 300, in other implementations, AR device 300 may include fewer components, additional components, different components, or differently arranged components than illustrated in FIG. 3. For example, AR device 300 may include a speaker to output audio data to an associated user. Furthermore, one or more components of AR device 300 may perform one or more tasks described as being performed by one or more other components of AR device 300.

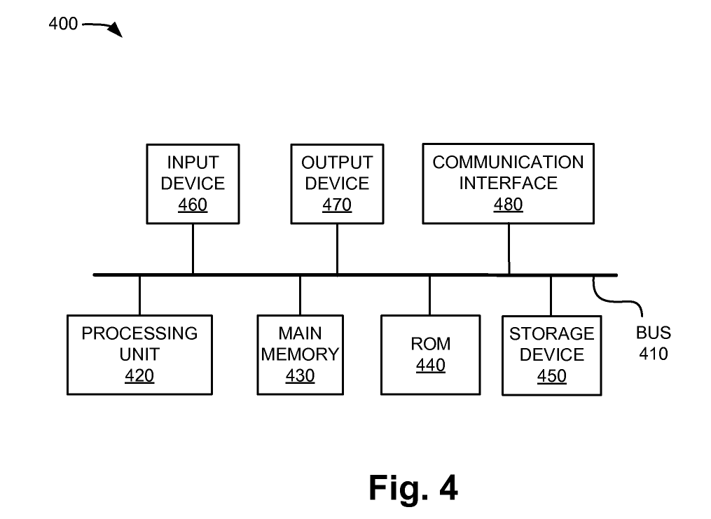

FIG. 4 is a diagram of exemplary components of a device 400 that may correspond to one or more devices of environment 100, such as first user device 110-A, second user device 110-B, a component of network 120 (e.g., a router), or document generator 130. As illustrated, device 400 may include a bus 410, a processing unit 420, a main memory 430, a ROM 440, a storage device 450, an input device 460, an output device 470, and/or a communication interface 480. Bus 410 may include a path that permits communication among the components of device 400.

Processing unit 420 may include one or more processors, microprocessors, or other types of processing units that may interpret and execute instructions. Main memory 430 may include a RAM or another type of dynamic storage device that may store information and instructions for execution by processing unit 420. ROM 440 may include a ROM device or another type of static storage device that may store static information and/or instructions for use by processing unit 420. Storage device 450 may include a magnetic and/or optical recording medium and its corresponding drive.

Input device 460 may include a mechanism that permits an operator to input information to device 400, such as a keyboard, a mouse, a pen, a microphone, voice recognition and/or biometric mechanisms, etc. Output device 470 may include a mechanism that outputs information to the operator, including a display, a printer, a speaker, etc.

Communication interface 480 may include any transceiver-like mechanism that enables device 400 to communicate with other devices and/or systems. For example, communication interface 480 may include mechanisms for communicating with another device or system via network 120. For example, if user device 110 is a wireless device, such as a smart phone, communication interface 480 may include, for example, a transmitter that may convert baseband signals from processing unit 420 to radio frequency (RF) signals and/or a receiver that may convert RF signals to baseband signals. Alternatively, communication interface 480 may include a transceiver to perform functions of both a transmitter and a receiver. Communication interface 480 may further include an antenna assembly for transmission and/or reception of the RF signals, and the antenna assembly may include one or more antennas to transmit and/or receive RF signals over the air.

As described herein, device 400 may perform certain operations in response to processing unit 420 executing software instructions contained in a computer-readable medium, such as main memory 430. A computer-readable medium may be defined as a non-transitory memory device. A memory device may include space within a single physical memory device or spread across multiple physical memory devices. The software instructions may be read into main memory 430 from another computer-readable medium or from another device via communication interface 480. The software instructions contained in main memory 430 may cause processing unit 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of device 400, in other implementations, device 400 may include fewer components, different components, differently arranged components, or additional components than those depicted in FIG. 4. Alternatively, or additionally, one or more components of device 400 may perform one or more other tasks described as being performed by one or more other components of device 400.

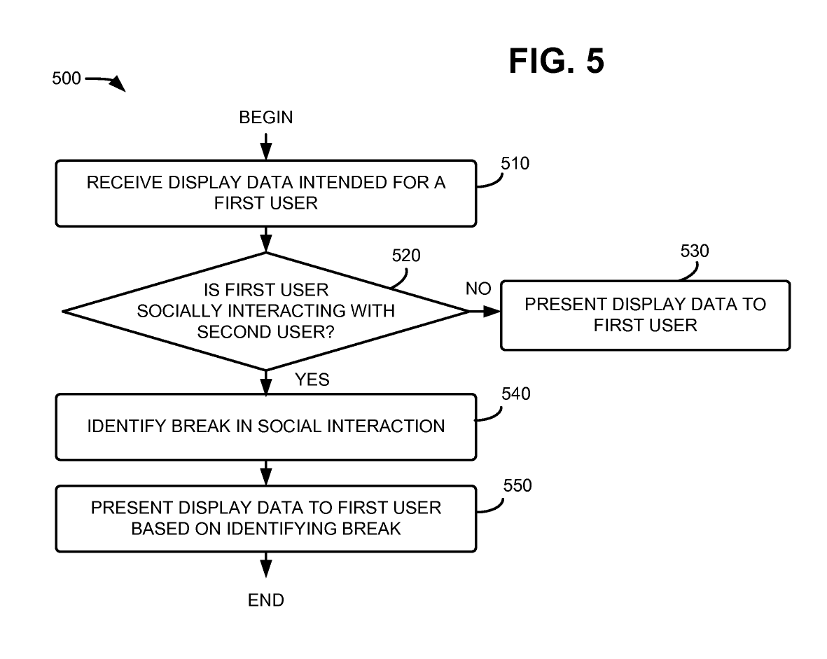

FIG. 5 is a flow chart of an exemplary process 500 for identifying and monitoring a social interaction between first user 101 and second user 102 and selectively providing display data 104 to first user 101 during an identified break in the social interaction. In one exemplary implementation, process 500 may be performed by first user device 110-A. In another exemplary implementation, some or all of process 500 may be performed by another device or collection of devices separate from or in combination with first user device 110-A, such as first user device 110-A in combination with second user device 110-B, document generator 130, or another component of environment 100.

As shown in FIG. 5, process 500 may include receiving display data 104 (block 520). For example, first user device 110-A may receive display data 104 from document generator 130 or another component not shown in FIGS. 1A-1D. For example, display data 104 may correspond to a (1) message forwarded from a message server or a short messaging service (SMS); or (2) a webpage or other data received from an application server.

Based on received display data 104, first user device 110-A may determine whether first user 101 is socially interacting with second user 102 (block 520). For example, as described above in the discussion of FIG. 1A, first user device 110-A may collect status data 103 regarding the operation of first user device 110-A and/or second user device 110-B. First user device 110-A may then evaluate a social interaction based on status data 103, such as to determine whether second user 102 moving away from first user 101 and/or is actively using second user device 110-B and, therefore, not engaged in a social interaction with first user 101. Additionally or alternatively, as described above in the discussion of FIGS. 1B-1D, first user device 110-A may collect first sensor data 105 and/or second sensor data 106 regarding first user 101, second user 102, and/or their surrounding environment, and first user device 110-A may evaluate a social interaction based on first sensor data 105 and/or second sensor data 106. For example, first user device 110-A may determine that first user 101 and second user 102 are engaged in a social interaction if second user 102 is looking toward first user 101 for a threshold duration of time.

As shown in FIG. 5, if first user 101 and second user 102 are not engaged in a social interaction (block 520-No), display data 104 may be presented to the first user second user 110-A without delay. For example, display 112-A (associated with first user device 110-A) may present display data 104 in an original form, as received by first user device 110-A in block 510.

Otherwise, if there is a social interaction between first user 101 and second user 102 (block 520-Yes), device 110-A may store display data 104 (e.g., in main memory 430) and may monitor the social interaction to identify a break in the social interaction (block 540). For example, first user device 110-A may evaluate status data 103, first sensor data 105, and/or second sensor data 106 to monitor the social interaction based on, for example, a position or movement of the first user 101 and second user 102; use of second user device 110-B, facial features of first user 101 and/or second user 102, dialog between first user 101 and second user 102, etc.

After a break in a social interaction is detected in block 540, first user device 110-A may present display data 104 based on identifying the break (block 550). In one example, first user device 110-A may present the original display data 104, as received in block 510, in response to detecting the break. In another example, a notification or a portion (e.g., an excerpt) of display data 104 may be presented to first user 101 based on identifying the break in the social interaction. If the break is very fast, display data 104 may be flashed to first user 101 (e.g., presented in front of first user's 101 eyes for less than a tenth of second).

In another implementation, display data 104 is presented during a detected break in a social interaction. For example, contents of display data 104 may be presented to first user 101 during the break, and presentation of the content may cease when the social interaction resumes (e.g., when dialog is detected, second user 102 is looking in the direction of first user 101, etc.). In another example, presentation of display data 104 may vary based on the duration of the social break. For example, first user device 110-A may present the original display data 104, as received in block 510, during the break and may cease presenting display data 104 after the break (e.g., when the social interaction resumes). Presentation of display data 104 may then resume during another break in the social interaction is identified.

In another example, the format of display data 104 may be modified so that it is presented in a less conspicuous manner to first user 101. For example, if first user 101 and second user 102 are in visual content (e.g., first user 101 and second user 102 are in close proximity and/or are communicating via a video conference through user device 110-A and 110-B or other devices), display data 104 may be converted into audio content and audibly played to first 101 in a manner that would not be noticeable to second user 102 (e.g., so that first user 101 can maintain eye content and/or display data 104 is not visible to second user 102).

In blocks 530 and/or 550, content from display data 104 may be presented by first user device 110-A to first user 101. Alternatively, first user device 110-A may send instructions to cause another device to present a portion of display data 104. For example, first user device 110-A may send (e.g., via a short range communications protocol such as Bluetooth® or WiFi®) instructions causing another device, such as a display device or a speaker, to present a portion of display data 104. Thus, a first device may detect the break, and a second, different device may present display data 104.

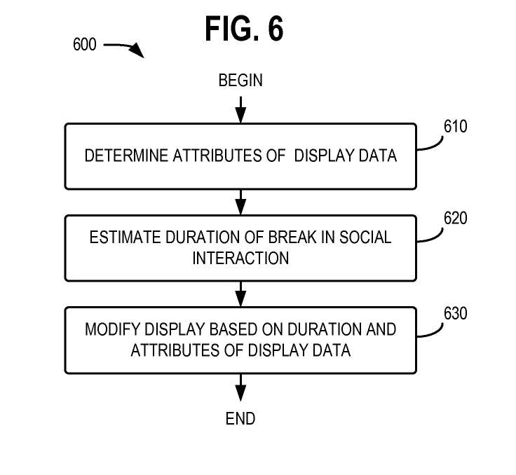

FIG. 6 shows a process 600 in which display data 104 is modified to enable first user 110-A to completely consume the modified display data 104 during the break in the social interaction. Process 600 may be performed by first user device 110-A. Alternatively, some or all of process 600 may be performed by another device or collection of devices separate from or in combination with first user device 110-A, such as first user device 110-A in combination with second user device 110-B, document generator 130, or another component of environment 100.

As shown in FIG. 6, process 600 may include determining attributes of display data 104 (block 610). For example, if display data 104 include text, first user device 110-A may determine the length of the text (e.g., number of words), the complexity of the text, and other factors that may influence an amount of time for first user 101 to read display data 104. For example, first user device 110-A may determine a length (e.g., number of words) associated with the original display data 104. First user device 110-A may further determine a complexity of the original document. For example, first user device 110-A may determine the average length (e.g., number of letters) of words, number of words used in sentences in the original document, number of sentences used in paragraphs, etc. If display data 104 include multimedia content, first user device 110-A may determine an expected playback time based on a size of the multimedia content, a protocol used to encode the multimedia content, metadata, etc.

Continuing with FIG. 6, process 600 may further include estimating a length of the break (block 620). For example, if the social break is associated with an activity, first user device 110-A may estimate an expected duration of the activity. For example, if first user device 110-A detects that second user 102 is reading and/or drafting a message (e.g., via second user device 110-B), first user device 110-A may estimate a break based on an estimated amount of time that second user would take to read and/or draft the message.

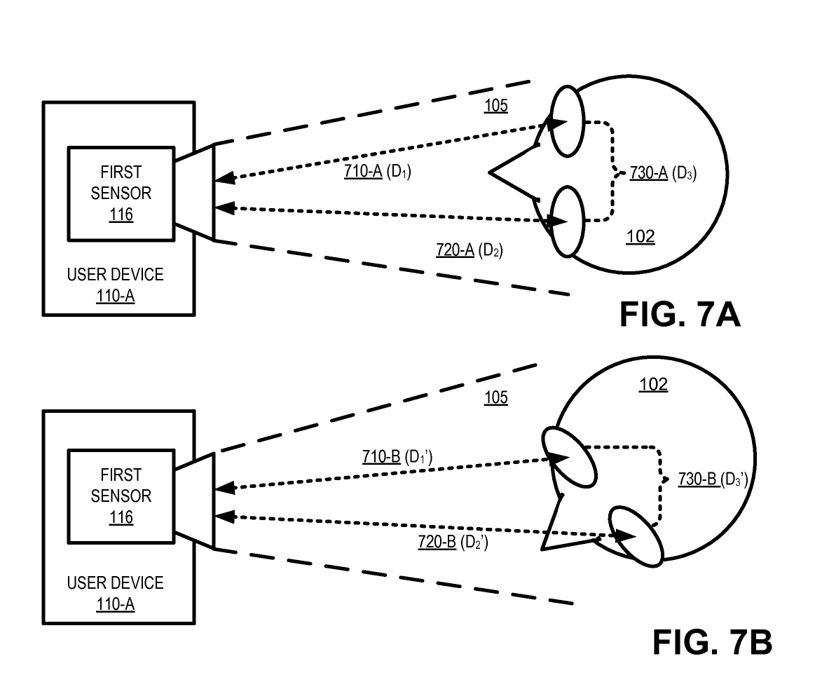

In another example, first user device 110-A may estimate a duration of the break based on movements of second user 102. For example, as shown in FIG. 7A, first user device 110-A., via first sensor 116, may capture first sensor data 105-A during the social interaction (e.g., when second user 102 is looking in the direction of first user device 110-A). First user device 110-A may process first sensor data 105-A to determine, for example, a first distance (D₁) 710-A between first image sensor 140 and second user's 102 left eye, a second distance (D₂) 720-A between first image sensor 140 and second user's 102 right eye, and/or a third distance (D₃) 730-A between second user's 102 left and right eyes. For example, first sensor 116 may measure first distance 710-A and second distance 710-B based on an amount of time and/or between (1) a photo-electric emission (e.g., a flash) from first user device 110-A, and (2) detection of a reflection of the emission by first sensor 116. Additionally or alternatively, sensor 116 may measure first distance 710-A and second distance 710-B based on an amount of intensity difference (i.e., reduction) between the photo-electric emission from first user device 110-A and detected reflection. First user device 110-A may then use trigonometry principles or other mathematical techniques to estimate third distance 730-A based on first distance 710-A and second distance 710-B.

Additionally or alternatively, first user device 110-A may estimate first distance 710-A and second distance 710-B based on eye sizes for second user 102 in image data captured by first sensor 116. For example, imaging data captured by first sensor 116 may detect second user 102 as having relatively larger eyes or other facial features as second user 102 moves closer to first sensor 116. First user device 110-A may estimate third distance 730-A based on comparing eye sizes for second user 102. For example, if one of second user's 102 eyes is relatively smaller or is partially blocked by second user's 102 nose other facial feature, first user device 110-A may determine that second user 102 is turned by an angle away from first user device 110-A, and the amount of the angle can be estimated based on the size difference.

As shown in FIG. 7B, when a movement or turn by second user 102 is detected, first user device 110-A may process first sensor data 105-B to determine, for example, a modified first distance (D₁′) 710-B, a modified second distance (D₂′) 720-B, and/or a modified third distance (D₃′) 730-B and compare these values to data collected during the social interaction (e.g., in FIG. 7A). First user device 110-A may then use a comparison of first distance (D₁) 710-A, second distance (D₂) 720-A, and/or third distance (D₃) 730-A to modified first distance (D₁′) 710-B, modified second distance (D₂′) 720-B, and/or modified third distance (D₃′) 730-B to determine an angle that second user 102 has turned away from first user device 110-A. First user device 110-A may then estimate a duration of the break based on the angle that second user 102 has turned away from first user device 110-A.

In one example, a break is detected only when second user 102 has turned away from first user 101 by more than a threshold angle (e.g., more than 30 degrees). The particular threshold angle can be dynamically determined by recording images of second user 102 and determining, for example, a threshold head angle movements associated with an end of dialog, movements away from first user 101, use of second user device 110-B, or other indications of a break in a social interaction. Thus, the threshold angle may vary to reflect different types of social interactions. For example, in some cultures, a younger second user 102 may turn away from first user 101 as a sign of respect, even when second user 102 is in a social interaction with first user 101 (i.e., no break is occuring).

Although FIGS. 7A and 7B show detection and estimation of the duration of a break based on head movements (e.g., an angle that second user 102 turns away from first user 101, the detection of the break and/or and estimating the duration of the break may be based on different and/or additional factors. For example, movements of first and second users' 101 and 102 eyes (e.g., as captured by a camera in first user device 110-A and/or as received by first user device 110-A from another image capturing device in the vicinity of first and second users 101 and 102). In this example, a break may be detected if, for example, second user's 102 eyes look away from first user 101, even if second user's 102 head remains in the direction of first user 101. Conversely, first user device 110-A may determine that a break is not occurring if, for example, second user's 102 eyes are look toward first user 101, even if second user's 102 head turns away from first user 101. In another example, sensors 116 and 118 may evaluate movement of first and second users 101 and 102 (e.g., data collected from accelerometer and/or gyroscope), muscle and/or brain activity data collected from various sensors, such as positron emission tomography (PET), electroencephalography (EEG), magnetic resonance imaging (MRI), electromyography (EMG), electrocardiography (EKG), etc.

Referring back to FIG. 6, process may include modifying display data 104 based on attributes of display data 104 and the estimated duration of the break (block 630). As previously described, if the estimated duration of the break does not correspond to an amount of time for first user 101 to read, view, or otherwise consume display data 104, document generator 130 may modify display data 104. For example, if the estimated break is shorter in duration than the amount of time for first user 101 to consume display data 104, document generator 130 may modify the original document to form a shorter, modified document that can be used (e.g., viewed, read, etc.) by first user 101 in less time. Conversely, if the break duration is more than the expected time needed to read the original document, document generator 130 may modify to the original display data 104 to form a longer and/or more complex document.

For example, document generator 130 may modify a layout (e.g., to change the position of images, charts, page breaks, text size, etc.) of the original document presenting display data 104 to achieve a desired reading time. For example, if first user 101 takes some time to view certain types of images (e.g., images of certain size colors, content, etc.), document generator 130 may add that type of images when generating display data 104 that first user 101 can read in a longer time or may remove this type of images to generate display data 104 that first user 101 can read in a shorter time.

While a series of blocks has been described with regard to processes 500 and 600 shown in FIGS. 5 and 6, the order of the blocks may be modified in other implementations. Further, non-dependent blocks may be performed in parallel. In another implementation, it should be appreciated that processes 500 and 600 may include additional blocks and/or one or more of blocks may be modified to include additional/less actions. For example, process 500 may further include identifying a second, subsequent break in the social interaction (after presenting display data 104), and first user device 110-A may present an interface to enable first user 101 to input a response to display data 104.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms “comprises” and “comprising,” when used in this specification, are taken to specify the presence of stated features, integers, steps or components but do not preclude the presence or addition of one or more other features, integers, steps, components or groups thereof.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a processor associated with a first user device and during a first time period, data to be displayed to a first user associated with the first user device;
determining, by the processor, whether the first user is engaged in a social interaction with a second user during the first time period;
presenting, by the processor, the data for display to the first user during the first time period when the first user and the second user are not engaged in the social interaction during the first time period;
when the first user is engaged in the social interaction with the second user during the first time period, determining, by the processor, a second time period associated with a break in the social interaction, wherein the second time period is subsequent to the first time period; and
when the first user is engaged in the social interaction with the second user during the first time period, presenting, by the processor, the data for display to the first user during the second time period.

2. The method of claim 1, wherein determining whether the first user is engaged in the social interaction with the second user during the first time period includes:
obtaining status data regarding a second user device associated with the second user, and
determining whether the first user is engaged in the social interaction with the second user during the first time period based on the status data.

3. The method of claim 2, wherein determining whether the first user is engaged in the social interaction with the second user during the first time period based on the status data includes:
determining, based on the status data, whether the second user is performing an action on the second user device during the first time period, and
determining that the first user is engaged in the social interaction with the second user during the first time period when it is determined that the second user is not performing the action on the second user device during the first time period.

4. The method of claim 3, wherein determining the second time period associated with the break in the social interaction includes:
determining, based on the status data, that the second user is performing the action on the second user device during the second time period.

5. The method of claim 2, wherein determining whether the first user is engaged in the social interaction with the second user during the first time period based on the status data includes:
determining, based on the status data, a distance between the first user device and the second user device; and
determining that the first user is engaged in the social interaction with the second user during the first time period when the distance between the first user device and the second user device is less than a threshold distance during the first time period.

6. The method of claim 5, wherein determining the second time period associated with the break in the social interaction includes:
determining, based on the status data, that the distance between the first user device and the second user device exceeds the threshold distance during the second time period.

7. The method of claim 1, wherein determining whether the first user is engaged in the social interaction with the second user during the first time period includes:
collecting sensor data; and
determining, based on the sensor data, that the first user is engaged in the social interaction with the second user during the first time period when the second user is looking in a direction of the first user for at least a first threshold duration during the first time period.

8. The method of claim 7, wherein determining the second time period associated with the break in the social interaction includes:
determining, based on the sensor data, that the second user is turned away from the first user for at least a second threshold duration during the second time period.

9. The method of claim 1, wherein presenting the data for display to the first user during the second time period includes:
determining an attribute of the data;
estimating a duration of the break;
determining, based on the attribute of the data, whether the first user can consume the data during the duration of the break; and
presenting the data for display to the first user during the break based on determining that the first user can consume the data during the duration of the break.

10. The method of claim 9, wherein presenting the data for display to the first user during the second time period includes:
modifying the data based on determining that the first user cannot consume the data during the duration of the break, wherein the first user can consume the modified data during the duration of the break; and
presenting the modified data for display to the first user during the break.

11. A device comprising:
a memory configured to store instructions; and
a processor configured to execute one or more of the instructions to:
receive, during a first time period, data to be displayed to a first user,
determine whether the first user is engaged in a social interaction with a second user during the first time period,
present the data for display to the first user during the first time period when the first user and the second user are not engaged in the social interaction during the first time period,
determine, when the first user is engaged in the social interaction with the second user during the first time period, a second time period associated with a break in the social interaction, wherein the second time period is subsequent to the first time period, and
present, when the first user is engaged in the social interaction with the second user during the first time period, the data for display to the first user during the second time period associated with the break.

12. The device of claim 11, wherein the processor, when executing the one or more instructions to determine whether the first user is engaged in the social interaction with the second user during the first time period, is further configured to:
determine whether the second user is performing, during the first time period, an action on a user device associated with the second user, and
determine that the first user is engaged in the social interaction with the second user during the first time period when the second user is not performing the action on the user device during the first time period, and
wherein the processor, when executing the one or more instructions to determine the second time period associated with the break in the social interaction, is further configured to determine that the second user is performing the action on the user device during the second time period.

13. The device of claim 11, wherein the processor, when executing the one or more instructions to determine whether the first user is engaged in the social interaction with the second user during the first time period, is further configured to:
determine a distance between the device to the second user, and
determine that the first user is engaged in the social interaction with the second user during the first time period when distance between the device to the second user is less than a threshold distance during the first time period, and
determine that the distance between the device to the second user exceeds the threshold distance during the second time period when the processor determines the second time period associated with the break in the social interaction.

14. The device of claim 11, further comprising a sensor to collect sensor data regarding the second user, and
wherein the processor, when executing the one or more instructions to determine whether the first user is engaged in the social interaction with the second user during the first time period, is further configured to determine, based on the sensor data, that the first user is engaged in the social interaction with the second user during the first time period when the second user is looking in a direction of the first user for at least a first threshold duration during the first time period, and
wherein the processor, when executing the one or more instructions to determine the second time period associated with the break in the social interaction is further configured to determine, based on the sensor data, that the second user is turned away from the first user for at least a second threshold duration during the second time period.

15. The device of claim 11, wherein the processor, when executing the one or more instructions to present the data for display to the first user during the second time period is further configured to:
determine an attribute of the data,
estimate a duration of the break,
determine, based on the attribute of the data, whether the first user can consume the data during the duration of the break,
present the data for display to the first user during the break when the first user can consume the data during the duration of the break, and
when the first user cannot consume the data during the duration of the break, modify the data and present the modified data for display to the first user during the break.

16. The device of claim 15, wherein the processor, when executing the one or more instructions to determine the attribute of the data, is further configured to determine a quantity of words included in the data, and
wherein the processor, when executing the one or more instructions to determine whether the first user can consume the data during the duration of the break is further configured to:
identify a reading speed associated with the first user, and
determine, based on the reading speed, whether the first user can read the quantity of words included in the data during the break.

17. The device of claim 11, wherein the device includes an augmented reality (AR) glasses.

18. A non-transitory computer-readable medium to store instructions, the instructions comprising:
one or more instructions that, when executed by a processor, cause the processor to:
receive, during a first time period, data to be displayed to a first user,
determine whether the first user is engaged in a social interaction with a second user during the first time period,
present the data for display to the first user during the first time period when the first user and the second user are not engaged in the social interaction during the first time period,
determine, when the first user is engaged in the social interaction with the second user during the first time period, a second time period associated with a break in the social interaction, wherein the second time period is subsequent to the first time period, and
present, when the first user is engaged in the social interaction with the second user during the first time period, the data for display to the first user during the second time period associated with the break.

19. The non-transitory computer-readable medium of claim 18, wherein the one or more instructions, when causing the processor to determine whether the first user is engaged in the social interaction with the second user during the first time period, further cause the processor to:
collect sensor data, and
determine, based on the sensor data, that the first user is engaged in the social interaction with the second user during the first time period when the second user is looking in a direction of the first user for at least a first threshold duration during the first time period, and
wherein the one or more instructions, when causing the processor to determine the second time period associated with the break in the social interaction, further cause the processor to:
determine, based on the sensor data, that the second user is turned away from the first user for at least a second threshold duration during the second time period.

20. The non-transitory computer-readable medium of claim 18, wherein the one or more instructions, when causing the processor to present the data for display to the first user during the second time period, further cause the processor to:
determine an attribute of the data,
determine a duration of the break,
modify the data based on the duration of the break and the attribute of the data, wherein the first user can consume the modified data during the duration of the break, and
present the modified data for display to the first user during the break.
